(19) United States
(12) Patent Application Publication
(10) Pub. No.: US 2026/0212221 A1
(43) Pub. Date: Jul. 23, 2026

(54) SYSTEM AND METHOD FOR GENERATING A PREDICTION MODEL BASED ON AN INPUT DATASET

(71) Applicant: ESCULPIR VERDADE S.A., Lisbon (PT)

(72) Inventor: Marcelo ADORNI PEREIRA, Charneca da Caparica (PT)

(73) Assignee: ESCULPIR VERDADE S.A., Lisbon (PT)

(21) Appl. No.: 19/137,166

(22) PCT Filed: Dec. 12, 2023
(86) PCT No.: PCT/IL2023/051263

§ 371 Date: Jun. 9, 2025

Related U.S. Application Data
(60) Provisional application No. 63/386,996, filed on Dec. 12, 2022.

(51) Int. Cl. G06N 5/04

(52) U.S. Cl. CPC G06N 5/04

(57) ABSTRACT

A method, system and computer program are presented. The method includes: providing a training data set and training a selected number of prediction models using a first portion of said training data set, thus providing first-generation prediction models. Processing the first-generation prediction models using evolutionary processing and generating next-generation prediction models. Training the next-generation prediction models using the first portion of training data and generating a number of current-generation prediction models. Processing said selected number of current-generation prediction models using evolutionary processing and generating a selected number of next-generation prediction models. Repeating training and evolving the selected number of predication models to obtain an accuracy measure within selected accuracy threshold and providing output data indicative of a selected number of preduction models.

### TECHNOLOGICAL FIELD

The present disclosure relates to techniques for generating one or more prediction models for prediction of selected output data in accordance with input data. The technique of the disclosure is specifically useful in prediction of blood biomarkers' concentrations based on spectrometric measurements.

### BACKGROUND

Analysis of blood biomarkers is one of the most widely used medical tests. The blood generally includes a plurality of biomarkers that provide valuable information on an individual's general health. To obtain data on blood biomarkers, a clinical specialist/physician typically draws a blood sample from an individual's vein, and the blood sample is transmitted to be tested in a laboratory, to obtain quantitative data on the individual's blood biomarkers.

Prediction models, and general machine learning processing techniques generally require certain training of a processing module based on input data. Such training typically relates to processing of input data and adjusting certain processing elements in order to minimize a cost function. Such a cost function may be indicative of a difference between the processing output and expected output, given the input data.

Various techniques have been described for simplifying the blood testing process. Such techniques generally include various techniques that relate to chemical testing of the blood sample, as well as the use of one or more prediction models to obtain data on one or more biomarkers.

U.S. Pat. No. 10,815,518 describes a sampler and a method of parameterization by calibration of digital circuits and non-invasive determination of the concentration of several biomarkers, simultaneously and in real time. The method makes use of equipment which, from a set of luminous signatures (spectrum) provided by a spectrophotometer (E5) (E6), applies a digital filter that breaks down the spectrum into sub-spectra that shows the digital signatures of relevant markers, and, through a digital decoder, the concentration of a set of several biomarkers is obtained simultaneously and in real time.

US 2006/281982 discloses an apparatus for non-invasive sensing of biological analytes in a sample, which includes an optics system having at least one radiation source and at least one radiation detector; a measurement system operatively coupled to the optics system; a control/processing system operatively coupled to the measurement system and having an embedded software system; a user interface/peripheral system operatively coupled to the control/processing system for providing user interaction with the control/processing system; and a power supply system operatively coupled to the measurement system, the control/processing system and the user interface system for providing power to each of the systems. The embedded software system of the control/processing system processes signals obtained from the measurement system to determine a concentration of the biological analytes in the sample.

### GENERAL DESCRIPTION

The term overfitting is associated with data analysis, and relates to an issue where calibration of selected data set correlates too closely to the selected data set. As a result, the overfitted calibration may fail to correspond to fit additional data provided as input in operational processes. The present disclosure provides a technique and respective system utilizing data processing for generating one or more prediction models suitable for prediction of one or more, and generally a group of, parameters in accordance with input data. The technique generally utilizes processing of a selected number of prediction models, each determined in accordance with different initial parameters, and which may be associated with different topologies, the selected number of prediction models evolving to generate further generations of prediction models. This evolutionary process is used to allow the prediction models to explore vast regions of parameter space, and thereby enable to limit the overfitting problem that may limit the prediction accuracy to input data of the training data set. In this connection, the terms evolutionary process, evolutionary processing, or evolutionary algorithms may refer to one or more techniques using optimization by means of population-based metaheuristic optimization (PBMOPT) algorithms.

In essence, the use of evolutionary processing techniques increases the probability of finding better local optima, or even the global optimum. In conventional optimization processes, and within a very wide solution space, when a set of gradient vectors converge towards a local optimum, the probability of finding better solutions, or even the global optimum, can be reduced. An evolutionary processing operation takes a population of current solutions and mixes and/or applies interference processes to the current solutions, to reposition some local optima in numerical ranges of said wide solution spaces that were not yet evaluated. With each generation of prediction models, a new population of solutions is generated.

In this connection, the present disclosure provides a method, typically implemented by one or more computers, or processor and memory circuitry (PMC). The method comprises providing a training data set, e.g., obtained from a storage unit or transmitted through network communication, and training a selected number of prediction models using at least a first portion of the training data set to provide a selected number of first-generation prediction models. The method further comprises processing of the selected number of first-generation prediction models using one or more evolutionary processing techniques, to generate a number of next generation prediction models. Each of the next-generation prediction models is further trained using said first portion of said training data, generating a number of current-generation prediction models. Further, each current-generation prediction model is processed by evolutionary processing to generate next-generation models, which are trained, starting from initial parameters determined by the evolutionary processing technique. The processing ends after a selected number of cycles, or when a selected accuracy measure reaches a selected threshold, or stabilizes, providing output data of the current-generation prediction model, acting as final-generation prediction models. In this connection the number of prediction models may be any selected number, such as 3, 5, 8, 12, 18, 23, 34, or any selected number of two or more prediction models.

Accordingly, the present disclosure provides a technique which utilizes a selected number, typically two or more, different prediction models for prediction of output data based on input data. The technique of the present disclosure further utilizes evolutionary processing (e.g., genetic algorithms) for mixing the prediction models. This provides for exploring parameter space of the prediction models while enhancing higher accuracy models. A number of evolutionary generations of the prediction models may optimize the prediction models and reduce risk of overfitting to specific training data.

Generally, the technique of the present disclosure may be directed at prediction of a selected number of blood biomarkers based on input data comprising spectrometric data obtained from an individual. In this connection, a training data set may generally be in the form of spectrometric data obtained from the skin of a plurality of individuals, and respective blood biomarkers' data of said individuals. Such a training data set generally includes blood biomarkers' data obtained by laboratory analysis of blood samples of the plurality of individuals, for blood samples collected at a time close to time of collection of the spectrometric data.

The present disclosure further utilizes the use of a plurality of prediction models in operational phase, to predict a selected group of output data pieces in response to selected input data, and provide reliable data on prediction accuracy. More specifically, the present disclosure further utilizes receiving input data and operating a selected number of trained prediction models to predict a set of output data pieces based on the input data. The disclosure still further includes processing the predicted output data pieces and determining one or more statistical parameters relating to prediction output from the different prediction models, and determining at least variation of said prediction output from the different prediction models with respect to first and second threshold limits. If variation of the output data pieces is within a first threshold limit, the technique provides output data comprising average prediction of the prediction output. If the variation exceeds a first threshold, but is within limits of a second threshold, the technique provides output data comprising a set of the prediction output data pieces. If the variation exceeds the second threshold limits, the technique provides an output indicating unreliability of the prediction.

This may be advantageous in prediction of biomedical parameters, where regulatory requirements typically demand an indication of accuracy of analysis and measurement. The present technique may be used in prediction of a selected group of biomarkers, based on spectrometric data obtained from a user's living tissue.

Thus, according to a broad aspect, the present disclosure provides a method implemented by a processor and memory circuitry (PMC), the method comprising:
a. providing a training data set;
b. training a selected number of prediction models using at least a first portion of said training data set to provide a selected number of first-generation prediction models;
c. processing said selected number of first-generation prediction models using one or more evolutionary algorithm processes, and generating a selected number of next-generation prediction models;
d. training said selected number of next-generation prediction models using said first portion of said training data, generating a number of current-generation prediction models;
e. processing said selected number of current-generation prediction models using one or more evolutionary algorithm processing techniques, and generating a selected number of next-generation prediction models;
f. repeating actions (d) and (e) for a selected number of generations until an accuracy measure of current-generation prediction models reaches a preselected training accuracy threshold;
g. providing output data comprising a selected number of current-generation prediction models.

According to some embodiments, training a selected number of prediction models (b) comprises determining random initial parameters for each prediction model and training said prediction models starting from said random initial parameters.

According to some embodiments, training said selected number of next-generation prediction models (d) comprises using parameters of said next-generation prediction models as initial parameters for training.

According to some embodiments, processing said selected number of current-generation prediction models using one or more evolutionary algorithm processing techniques comprises introducing a selected ratio of mutations in said evolutionary algorithm processing.

According to some embodiments, the method may further comprise validating training status of said selected current-generation prediction models using at least a second portion of said training data set.

According to some embodiments, the method may further comprise determining an accuracy measure for validation training of said selected current-generation prediction models, and repeating training (d) if the accuracy measure is below a selected threshold.

According to some embodiments, the method may further comprise mixing said first and second portions of the training data set for repeating training.

According to some embodiments, the method may further comprise testing said selected number of current-generation prediction models using at least a third portion of the training data set and determining testing accuracy measure for said selected number of current-generation prediction models. According to some embodiments, the method may further comprise determining a testing accuracy measure, with respect to a preselected accuracy threshold, and if said testing accuracy measure is below a preselected threshold, generating a request for additional training data.

According to some embodiments, said training data set comprises spectrogram data pieces obtained from a plurality of individuals and respective data on a selected set of blood biomarkers of said individuals, said training said prediction model being directed at prediction of a selected group of biomarkers based on input spectrogram data of an individual.

According to some embodiments, said selected group of biomarkers comprises biomarkers selected in accordance with the biological correlation between them.

According to some embodiments, said selected group of biomarkers comprises two or more biomarkers characterized by a typical spectral effect above a first threshold, and one or more biomarkers characterized by a typical spectral effect below a second threshold.

According to some embodiments, selecting one or more groups of biomarkers comprises pairing two or more biomarkers characterized by typical spectral effect above a first threshold, and one or more biomarkers characterized by typical spectral effect below a second threshold.

According to some embodiments, said spectrogram data obtained from a plurality of individuals comprises a plurality of spectrogram readings collected within a selected timeframe associated with blood circulation of a selected portion of an individual's blood volume.

According to some embodiments, said spectrogram data is indicative of spectral absorption within a range between 600-2700 nm.

According to some embodiments, said selected number of prediction models comprises prediction models having different topologies between them.

According to some embodiments, said selected number of prediction models comprises prediction models selected from a group comprising: Principal Component Analysis, Principal Component Regression, Partial Least Squares, Parallel Factor Analysis, N-way Partial Least Squares, Multiple Linear Regression, Spectral Match Value, Moving Block, Hierarchical Cluster Analysis, K-nearest Neighbors, Support Vec Machines, Naïve Bayes, Linear or Normal Discriminant Analysis, Soft Independent Modeling of Class Analogy, Feedforward Neural Network, Recurrent Neural Network, Bayesian Regularization, Convolutional Neural Network, and/or a Generative Adversarial Network.

According to some embodiments, the method may further comprise storing said output data comprising a selected number of current-generation prediction models in a computer readable medium in the form of a set of pre-trained prediction models for use in prediction of blood biomarkers based on input data comprising spectrometric data obtained by non-invasive spectrometric reading of an individual's living tissue.

According to some embodiments, the use in prediction of blood biomarkers comprises:
obtaining, using a spectrometer, one or more spectrograms from an individual's living tissue;
processing said one or more spectrograms using said set of pre-trained prediction models to obtain a set of predictions for one or more biomarkers;
processing said set of predictions for said one or more biomarkers and determining at least a statistical variation between predictions of said set of pre-trained prediction models;
processing said statistical variation and determining relation of said statistical variation to at least first and second variation limits, such that:
if statistical variation is within the first variation limit, determining output data comprising an average of said output prediction data pieces;
if statistical variation is within the second variation limit, determining output data comprising said output prediction data pieces and said statistical variation; and
if statistical variation data is outside said second variation limit, determining output data as being undetermined; and
generating an output signal comprising said output data indicating one or more biomarkers of said individual.

According to some embodiments, the set of pre-trained prediction models is configured to predict a common set of biomarkers.

According to some embodiments, said determining at least statistical variation comprises determining percentage variation.

According to some embodiments, said first threshold is between 5% and 15% variation.

According to some embodiments, said second threshold is between 20% and 30% variation.

According to one other broad aspect, the present disclosure provides a program storage device readable by machine, tangibly embodying a program of instructions executable by the machine to perform a method comprising:
providing a training data set;
training a selected number of prediction models using at least a first portion of said training data set to provide a selected number of first-generation prediction models;
processing said selected number of first-generation prediction models using one or more evolutionary algorithm processing techniques, and generating a selected number of next-generation prediction models;
training said selected number of next-generation prediction models using said first portion of said training data, generating a number of current-generation prediction models;
processing said selected number of current-generation prediction models using one or more evolutionary algorithm processing techniques, and generating a selected number of next-generation prediction models;
repeating said training of said next generation prediction models to generate a number of current-generation prediction models, and processing said selected number of current-generation prediction models using one or more evolutionary algorithm processing techniques, and generating a selected number of next-generation prediction models for a selected number of generations, until an accuracy measure of current-generation prediction models reaches a preselected training accuracy threshold; and
providing output data comprising a selected number of current-generation prediction models.

According to a further broad aspect, the present disclosure provides a system comprising a processor and memory circuitry (PMC), wherein the PMC is configured to:
a. obtain a training data set;
b. utilize at least a first portion of said training data set to train a selected number of prediction models and provide a selected number of first-generation prediction models;
c. process said selected number of first-generation prediction models by one or more evolutionary algorithm processing techniques, and generating a selected number of next-generation prediction models;
d. train said selected number of next-generation prediction models using said first portion of said training data, generating a number of current-generation prediction models;
e. process said selected number of current-generation prediction models using one or more evolutionary algorithm processing techniques, and generating a selected number of next-generation prediction models;
f. repeat actions (d) and (e) for a selected number of generations until an accuracy measure of current-generation prediction models reaches a preselected training accuracy threshold; and
g. provide output data comprising a selected number of current-generation prediction models.

According to one other broad aspect, the present disclosure provides a method for use in prediction of output data in response to input data, the method comprising: providing a set of pre-trained prediction models;
processing said input data by said set of prediction models and obtaining output prediction data pieces;
processing said output prediction data pieces and determining at least statistical variation between said output prediction data pieces;
processing said statistical variation and determining relation of said statistical variation to at least first and second variation limits, such that:
if statistical variation is within the first variation limit, determining output data comprising an average of said output prediction data pieces;
if statistical variation is within the second variation limit, determining output data comprising said output prediction data pieces and said statistical variation; and
if statistical variation data is outside said second variation limit, determining output message as being undetermined; and
generating an output signal comprising said output data.

According to some embodiments, said input data comprises one or more spectrograms obtained from an individual's living tissue.

According to some embodiments, said one or more spectrograms comprise data indicative of spectral absorption within a range between 600-2700 nm.

According to some embodiments, said output data comprises data on concentration of one or more biomarkers in the blood of said individual.

According to some embodiments, said determining at least statistical variation comprises determining percentage variation.

According to some embodiments, said first threshold is between 5% and 15% variation.

According to some embodiments, said second threshold is between 20% and 30% variation.

According to yet another broad aspect, the present disclosure provides a program storage device readable by machine, tangibly embodying a program of instructions executable by the machine to perform a method comprising:
providing a set of pre-trained prediction models;
processing said input data by said set of prediction models and obtaining output prediction data pieces;
processing said output prediction data pieces and determining at least statistical variation between said output prediction data pieces;
processing said statistical variation and determining relation of said statistical variation to at least first and second variation limits, such that:
if statistical variation is within the first variation limit, determining output data comprising an average of said output prediction data pieces;
if statistical variation is within the second variation limit, determining output data comprising said output prediction data pieces and said statistical variation; and
if statistical variation data is outside said second variation limit, determining output message as being undetermined; and
generating output signal comprising said output data.

According to a further broad aspect, the present disclosure provides a system comprising a processor and memory circuitry (PMC), wherein said memory comprises a set of pre-trained prediction models, wherein the PMC is configured to:
obtain input data comprising one or more spectrogram data obtained from an individual's living tissue;
process said input data by each of said set of prediction models and obtain output prediction data pieces indicative of one or more biomarkers in said individual's blood;
process said output prediction data pieces and determine at least statistical variation between said output prediction data pieces;
process said statistical variation and determine relation of said statistical variation to at least first and second variation limits, such that:
if statistical variation is within the first variation limit, determine output data comprising an average of said output prediction data pieces;
if statistical variation is within the second variation limit, determine output data comprising said output prediction data pieces and said statistical variation; and
if statistical variation data is outside said second variation limit, determine output message as being undetermined; and
generate output signal comprising said output data.

According to some embodiments, the system may further comprise a spectrometer unit. According to some embodiments, the spectrometer unit may be configured to provide spectrogram data indicative of spectral absorption within a range between 600-2700 nm.

According to yet another broad aspect, the present disclosure provides a computer program product comprising a computer useable medium having computer readable program code embodied therein for use in prediction of output data in response to input data, the computer program product comprising:
computer readable program code for causing the computer to provide a set of pre-trained prediction models;
computer readable program code for causing the computer to process said input data by said set of prediction models and obtaining output prediction data pieces;
computer readable program code for causing the computer to process said output prediction data pieces and determining at least statistical variation between said output prediction data pieces;
computer readable program code for causing the computer to process said statistical variation, and determining relation of said statistical variation to at least first and second variation limits, such that:
computer readable program code for causing the computer to determine if statistical variation is within the first variation limit, and accordingly to determine output data comprising an average of said output prediction data pieces;
computer readable program code for causing the computer to determine if statistical variation is within the second variation limit, and accordingly to determine output data comprising said output prediction data pieces and said statistical variation; and
computer readable program code for causing the computer to determine if statistical variation data is outside said second variation limit, and accordingly to determine output message as being undetermined; and
computer readable program code for causing the computer to generate an output signal comprising said output data.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 exemplifies a method for training a prediction model system according to some embodiments of the present disclosure;

FIG. 2 exemplifies a computer system configured for operating according to some embodiments of the present disclosure;

FIG. 3 exemplifies a method for training a prediction model system with further details according to some embodiments of the present disclosure;

FIG. 4 exemplifies a method for use in prediction of one or more data pieces using a prediction model system according to some embodiments of the present disclosure;

FIG. 5 exemplifies a system for non-invasive determination of blood biomarkers according to some embodiments of the present disclosure;

FIGS. 6A and 6B exemplify spectrogram data (FIG. 6A) and spectrogram data labeled by biomarker data (FIG. 6B) according to some embodiments of the present disclosure;

FIG. 7 exemplifies prediction of cholesterol based on spectrogram data, and illustrates accuracy measure R² according to some embodiments of the present disclosure;

FIG. 8 exemplifies operation of evolutionary algorithms in processing of a set of prediction models according to some embodiments of the present disclosure;

FIG. 9 exemplifies a flow diagram illustrating training of a set of prediction models using evolutionary processing according to some embodiments of the present disclosure; and

FIGS. 10A to 10D exemplify prediction optimization according to some embodiments of the present disclosure with respect to conventional techniques. FIG. 10A illustrates a possible arrangement of solutions in a hypothetical solution domain, FIG. 10B illustrates expected divergence tendency associated with an optimization step following the state in FIG. 10A, FIG. 10C illustrates a possible arrangement of groups of solutions in a solution domain according to some embodiments of the present disclosure, and FIG. 10D exemplifies expected convergence tendency associated with an optimization step following the state in FIG. 10C according to some embodiments of the present disclosure.

### DETAILED DESCRIPTION OF EMBODIMENTS

As indicated above, the present disclosure provides a technique of generating a selected number of prediction models. The number of prediction models may be configured for predicting any selected parameter and may be formed by various selected topologies including various machine learning configurations, artificial neural network, PLS, ANN, CNN, PCA, PCR, NPLS, PARAFAC, etc. The technique of the present disclosure may be directed for determining biomarkers based on spectrometric readings from a patient's tissue, and may be used for determining a patient's blood biomarker levels.

In this connection, the term ‘blood biomarkers’ as used herein relates to any molecule, macromolecule, or cluster of molecules, that is, or may be present, in an individual's blood, and may be a target for a blood test analysis. The term blood biomarker may be used herein in combination with additional terms, such as marker, analyte, bio-analyte, and molecule, as used herein below.

Unless specifically stated otherwise, as apparent from the following discussions, it is appreciated that throughout the specification, discussions utilizing terms such as “obtaining”, “using”, “feeding”, “determining”, “estimating”, “generating” or the like, refer to the action(s) and/or process(es) of a computer that manipulate and/or transform data into other data, said data represented as physical, such as electronic, quantities and/or said data representing the physical objects.

The terms “computer” or “computerized system” should be expansively construed to include any kind of hardware-based electronic device with at least one data processing circuitry (e.g., digital signal processor (DSP), a CPU, a GPU, a TPU, a field programmable gate array (FPGA), an application specific integrated circuit (ASIC), microcontroller, microprocessor etc.). The processing circuitry can comprise, for example, one or more processors operatively connected to computer memory, loaded with executable instructions for executing operations, as further described below. The processing circuitry encompasses a single processor or multiple processors, which may be located in the same geographical zone, or may, at least partially, be located in different zones, and may be able to communicate together.

The present technique may utilize input data in the form of spectrogram data collected from an individual's living tissue by non-invasive testing means. Such an individual may be a patient at a clinic, home, or other place, or a user in the case of collection of a training data set, where at least some of the data is to be collected from healthy users. For example, the spectrogram may be collected using an optical spectrometer from an individual's skin, e.g., wrist, fingertip, forehead, arms, neck, chest, cheeks, legs, etc. Generally, body regions having high capillary blood flow or high capillary density may be preferred. The spectrogram data may be collected within an infrared portion of the electromagnetic spectrum, including wavelengths in the range between 600-2700 nm, or between 800-2700 nm. Generally, the present technique may be relevant for any range of wavelengths in which spectrogram data is obtained and is used for training the prediction model, as described herein below. Moreover, a spectrometer may be configured to obtain spectrogram data within a broader range. Such a spectrometer may also be suitable, while ranges, for which the prediction model is prepared, are used in analysis.

The term infrared, or near infrared (NIR), as used herein, relates to portions of the electromagnetic spectrum commonly known as infrared or near infrared. It should however be noted that the present technique may, in general, be used with other spectral ranges including e.g., visible spectrum, mid-infrared, and/or far infrared wavelength ranges. Typically, the near infrared spectrum in the range of 600-2700 nm, or 600-2000 nm, or 700-2000, or 700-2700 nm, or 800-2000 nm, or 800-2700 nm, is preferred for analysis of biomarkers, due to absorbance by functional groups characterizing biochemical compounds.

For example, the spectrogram data may include data on spectral absorbance/reflection within the selected range, using spectral resolution between 2 and 60 nm. As indicated herein, the spectrogram data may be acquired throughout a selected period of time, where a plurality of spectrograms are collected within a period of 1-300 seconds. Accordingly, a set of spectrogram data from an individual may include a plurality of spectrograms, each assigned with time of acquisition. The set of spectrograms may be averages to determine an average spectrogram readout of an individual.

The spectrogram data collected from an individual typically includes a list of absorption levels (often presented in a graph) indicating level of absorption of the individual tissue for different wavelengths within the selected range. The present technique preferably utilizes spectrogram data that includes a plurality of spectroscopic measurements obtained from living tissue, e.g., skin, of the user within a selected measurement time (e.g., 1-300 seconds, or 2-180 seconds, or about 120 seconds). Typically, collection of spectrogram data may take about a second, such that within the selected measurement time, a plurality of spectrogram measurements may be collected. The plurality of spectrogram measurements may vary in accordance with blood circulation through the individual's blood vessels, such that within a measurement time of about 90 seconds, the spectrogram measurements are indicative of entire blood volume circulating through the individual's body. Further, in some embodiments, collecting of spectrogram data for training of the prediction models as described herein below, may be performed within a selected measurement time. The so-collected plurality of spectrograms may be further analyzed for consistency, e.g., by determining standard variation of the spectrogram data between the different spectral measurements; spectrogram data pieces having standard deviation that exceeds a preselected threshold, may be determined as inconsistent, and thus may be omitted from the training data set.

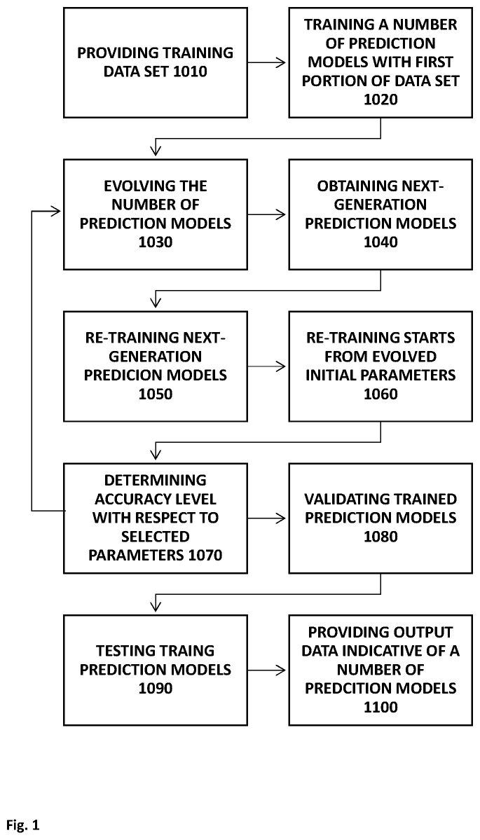

Reference is made to FIG. 1 exemplifying a method for training a selected number of prediction models according to some embodiments of the present disclosure. As shown, the method includes providing, or obtaining, training data set 1010. The training data set may be any type of training data and typically includes labeled data pieces. For example, the training data set may include a set of spectrogram data pieces from various individuals and respective data on concentration of one or more biomarkers in the respective individuals' blood. As indicated, the training data set may be obtained from computer storage, network storage, a remote data source etc.

Generally, in some embodiments, the present technique may utilize grouping of selected biomarkers in accordance with one or more parameters and generating respective prediction models for different groups of biomarkers. In this connection, the example of FIG. 1, and further examples provided herein, relate to a set of prediction models directed to predicting a selected group of biomarkers. Various sets of prediction models may be used in parallel or series for prediction of different groups of biomarkers.

Following obtaining the training data set, the present technique utilizes one or more computer systems, e.g., processor and memory circuits, for training a selected set of prediction models 1020. The selected set of prediction models may include a number of prediction models having selected one or more topologies, and utilize random different initial parameters for each of the prediction models. The initial training may function as calibration of the prediction models and may utilize a portion of the training data set generally assigned as a calibration data set. The calibrated prediction models are further processed using evolutionary processing 1030 for mixing and merging the trained prediction models and generating a number of next-generation prediction models 1040. Typically, the number of prediction models may be selected as two or more, or three or more prediction models. The actual number may vary between generations during evolutionary processing and may for example range between 2 and 50, or 3 and 25 prediction models.

In this connection, the term evolutionary processing, or evolutionary algorithms, as used herein, relates to one or more population-based processing techniques using a selected combination of processing mechanisms such as reproduction, mutation, and recombination. The technique of the present disclosure may utilize one or more specific evolutionary processing techniques such as genetic algorithms, genetic programming, evolutionary programming, differential evolution, neuroevolutionary, and/or one or more learning classifiers.

In some examples, the evolutionary processing may operate on the trained prediction models by evaluating the most successful models, selecting the successful models (optionally including selected less-successful models) for reproduction, breeding/merging the selected predictions models, and introducing certain level of stochastic/random mutations, to generate the next-generation prediction models.

The next-generation prediction models are generally formed based on parameters of trained prediction models of previous generations. To optimize prediction, the present technique utilizes additional training/calibration of the next-generation prediction models 1050 using the calibration portion of the training data set. While initial calibration typically utilizes random initial parameters, calibration/training of the next-generation prediction models utilizes initial parameters obtained from the evolutionary processing 1060, typically being a certain merge of the trained previous generation models. For simplicity, calibrated next-generation prediction models are referred to herein as current-generation prediction models.

Generally, the present technique may operate to evolve current generation prediction models to next-generation prediction models, and further calibrate the next generation prediction models for a selected number of generations. In some embodiments, the present technique may operate to determine an accuracy measure (e.g., R² parameter, or other selected accuracy measures) of the current-generation prediction models 1070 and repeat evolution and calibration processing if the accuracy measure is determined to be below a selected threshold. For example, the threshold may be selected as R²>0.6.2, or R²>0.7, or R²>0.72, such that for lower values of R², the evolutionary processing is repeated.

After completing a selected number of evolutionary cycles, or after determining that accuracy measure of the current-generation prediction models is within threshold limits, the present technique may provide output data on training prediction models. In some embodiments, the present technique may further proceed to validate the current-generation prediction models 1080 using a second portion of the training data set, generally not used for calibration. Generally, in some embodiments, the present technique may further determine accuracy measure of the prediction models following validation. If the accuracy measure is determined to be below the desired threshold, calibration and validation portions of the training data set may be shuffled between them, and the prediction models may be further evolved and calibrated as indicated in action 1030. Upon determining that accuracy measure is within the desired threshold limits, the prediction models may be tested 1090 using a third portion of the training data set, and if testing succeeds, output data in the form of a selected number of prediction models is generated 1110.

Generally, the selected set of prediction models may utilize various machine learning or Artificial Intelligence techniques, including, for example: Principal Component Analysis, Principal Component Regression, Partial Least Squares, Parallel Factor Analysis, N-way Partial Least Squares, Multiple Linear Regression, Hierarchical Cluster Analysis, K-nearest Neighbors, Support Vector Machines, Naïve Bayes, Linear or Normal Discriminant Analysis, Soft Independent Modeling of Class Analogy, Feedforward Neural Network, Recurrent Neural Network, Bayesian Regularization, Convolutional Neural Network, Generative Adversarial Network, or any other suitable prediction model configuration. Further, the prediction model may utilize a parallel or sequential chain of Artificial Intelligence techniques, chemometric techniques, and/or statistical modeling. The selected set of prediction models may utilize prediction models of different topologies. For example, the prediction models may differ in the number of nodes in each layer, number of processing layers, initial parameters, or other characteristics thereof.

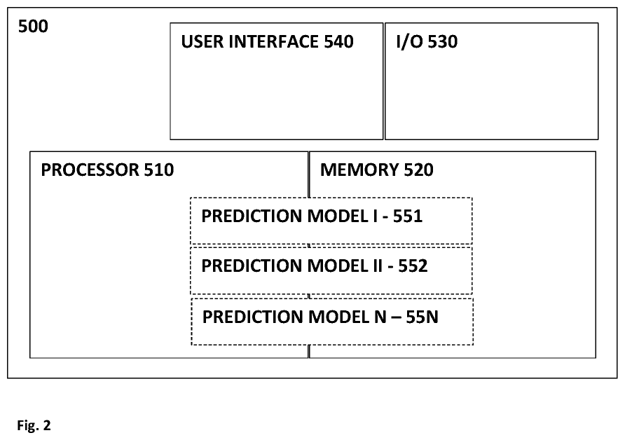

As indicated above, the method according to some embodiments of the present disclosure may be implemented using one or more processors and memory circuitry. FIG. 2 illustrates a computer-based system 500 for generating one or more prediction models in accordance with some embodiments of the present disclosure. System 500 includes at least one processor 510 and memory 520, typically defined as processor and memory circuitry (PMC). The system 500 also includes suitable input and output communication module 530, and may include user interface 540, e.g., including display, keyboard etc. The PMC is operative to implement one or more algorithms suitable for generating data indicative of a selected number of prediction models 551-55N in accordance with the technique described herein. In some additional embodiments described herein below, the PMC may be configured to implement the selected number of prediction models 551-55N in accordance with input data, e.g., indicative of one or more spectrograms collected from an individual's tissue, to provide output data indicative thereof (e.g., a selected list of biomarkers). In particular, the processor 510 can execute several computer-readable instructions implemented on a computer-readable memory stored or comprised in the PMC, wherein execution of the computer-readable instructions enables data processing of training input data, e.g., such as spectrogram data labelled by biomarker data, for generating prediction models and determining prediction model parameters.

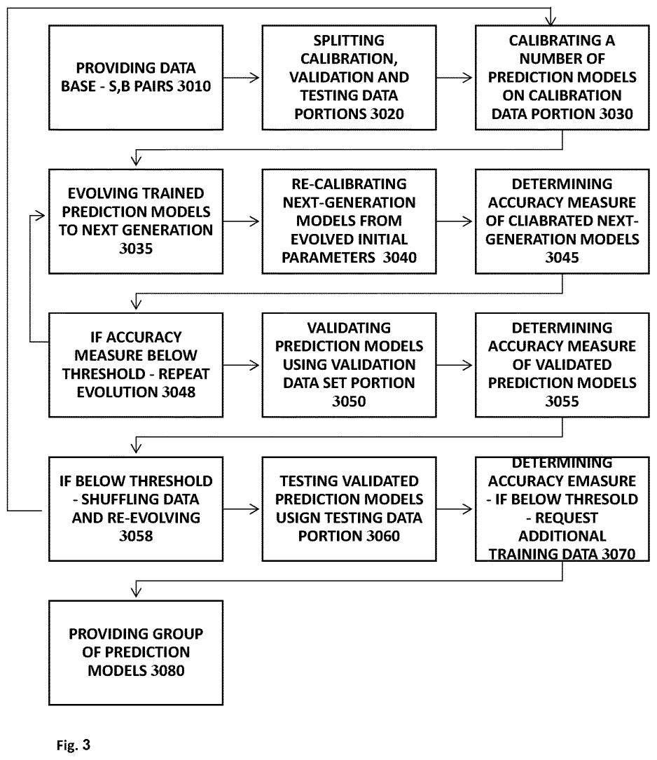

Reference is further made to FIG. 3 providing an additional example by means of a block diagram of a method for use in training prediction models according to some embodiments of the present technique. As shown, certain training data, e.g., a set of spectrograms obtained from a plurality of individuals S and respective blood biomarker data obtained from the same set of individuals and determined in a laboratory based on blood samples B, typically collected within a short time from obtaining the spectrogram data, is used as training data set 3010. The set of S-B pairs may be split into a calibration set (about 30%-60%, typically 40%), validation set (about 30%-60%, typically 40%), and testing set (about 10%-30%, typically 20%) 3020. The different sub-sets may be stored in a storage (memory, HDD), and the calibration set is used for calibrating a selected set of prediction models 3030. This initial calibration generally provides a selected number of trained prediction models. A selected one or more evolutionary processing techniques of the trained prediction models are applied to evolve the prediction models to form a set of next-generation prediction models 3035. Such evolutionary processing may generally include selecting successful prediction models in accordance with an accuracy measure thereof, merging parameters of the prediction models, and introducing certain random variations, to form the next-generation prediction models. Each of the next-generation prediction models is calibrated 3040 starting with initial parameters as obtained in the evolutionary processing to obtain a set of trained current-generation prediction models. Generally, the present technique may repeat evolutionary processing and calibrating of the next-generation prediction models for a selected number of generations. Further, in some embodiments of the present disclosure, the technique may operate to determine accuracy measure of the trained current-generation prediction models 3045, and if accuracy measure is below a selected threshold (e.g., R²<0.7, or 0.8, or 0.9) the technique may repeat evolutionary processing 3048 of the prediction models for additional generations. In some embodiments the technique of the present disclosure may operate to repeat evolutionary processing for a selected number of generations, and determine if the accuracy measure is within or below threshold limits. If the accuracy measure is determined to be below desired limits, the technique may operate to evolve the prediction models for a selected additional number of generations.

In this connection calibration of the prediction models may include variation of prediction parameters to minimize a selected loss function based on a comparison between predictions and the respective known target, to provide the smallest gap possible. The loss function may be optimized, i.e., the gap is made smaller, by any method known in the state of the art, such as, but not exclusively, by gradient descent applied to loss functions and algorithms derived therefrom, among others. Optimizing the loss function causes the parameters of the algorithm to alter, so that any value where the loss function is optimal can be reached. For cases with a low number of targets, the optimum of the loss function is easier to reach than in cases with a larger number of targets. In these cases, the loss function presents multiple optima, with the best optimum called the global optimum, and all others called local optima. The more targets there are, the harder it becomes to obtain the global optimum. Thus, the calibration stage may utilize one or more prediction model training techniques, such as stochastic gradient descent, or any other suitable training technique for prediction models, to bring the predicted output (Y) for each input spectrogram (S) closer to the respective blood biomarkers data (B).

In some embodiments, calibration may be sufficient. However, to ensure accuracy of the prediction models, the present technique may further validate and/or test accuracy thereof.

The second validation stage may be performed using a second portion of the data set. For each prediction route, accuracy of the predicted output (Y) is validated with respect to the actual blood biomarkers data (B) using data pieces of the second portion of the data set. The validation stage may include further optimization of the prediction route to minimize the respective loss model. Following the validation stage, data indicative of the loss function may be processed in accordance with a respective threshold associated with expected results. If the prediction accuracy is insufficient, the first and second portions of the data set may be reshuffled, and re-split, and the calibration and validation stages may be repeated. In some configurations, specifically following insufficient accuracy determined following testing of the prediction model, an additional training data set may be required. In this case, the system, e.g., using the computer processor of the PMC (as defined herein below) may generate an output signal requesting an additional data set.

The third testing stage includes testing of the prediction model accuracy on a third portion of the data set. The testing stage may generally avoid further optimization of the prediction model, and directly test accuracy thereof using input data (S) and target output (B) that was not used in the calibration and validation stages. If the prediction accuracy of output data (Y) is insufficient, in accordance with a selected threshold, an additional reference data set, in the form of spectrogram data (S) and blood biomarker data (B) may be requested, and calibration and validation stages may be repeated using the existing and additional data.

Generally, in some embodiments, the present technique may provide fully trained prediction models following a selected number of evolution generations. However, in some embodiments, following a selected number of generations being prepared, and the accuracy measure being within desired limits, the present technique may proceed to validating prediction results of the prediction models 3050. To this end the present technique may utilize a selected validation data set, selected from the initial data set used for training. Again, accuracy measure following calibration may be determined 3055, and, if below a desired threshold, the training data sets directed at calibration and at validation may be shuffled and the training process may repeat 3058.

At this stage, the prediction models may be further tested 3060, using a third, unused, portion of the data set. Generally, calibration and testing are used to estimate and avoid over-fitting of the prediction models to an initial training data set. To this end, additional elements of the training data may be used to verify that the prediction models can infer additional data to ensure that it is trained on directly. In some situations, where accuracy measure following testing is insufficient, i.e., below a desired threshold, the training process cannot proceed with the same training data set, and the present technique may operate to generate a request for additional training data 3070.

If, however, the accuracy measure is determined to be within desired limits, training of the prediction models is complete, and the present technique may generate output data indicating the group of prediction models 3080. The output data may be in the form of an indication to a user, and may include one or more data tables and/or computer readable instructions enabling one or more processors to operate the so-trained prediction models.

In this connection, it should be noted that the use of evolutionary processing within training operation of the one or more prediction models provides an efficient technique for exploring various regions of solution space, which is not necessarily explored in conventional training processes. This is specifically advantageous in prediction of multidimensional data such as prediction of a group of blood biomarkers based on spectrogram data obtained from an individual.

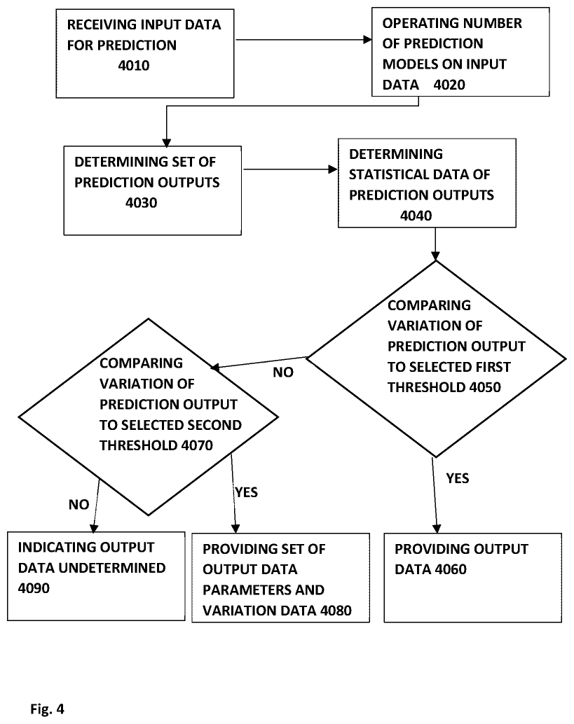

Further, according to some embodiments of the present disclosure, the use of a plurality of prediction models enables operation for prediction of one or more biomedical data pieces based on input data collected by a non-invasive technique and providing output data on accuracy and error level of the prediction. Thus, the use of a selected number of prediction models, typically different between them in at least one of topology and initial parameters, provides for increased accuracy, mitigates overfitting, provides for enhancing accuracy of prediction, and enables output data indicative of prediction accuracy. In this connection FIG. 4 exemplifies a method for use in prediction of output data in response to input data according to some embodiments of the present disclosure. As illustrated, FIG. 4 exemplifies the operation phase for prediction of data, typically one or more biomedical parameters in response to input data. Here, input data is provided to a computer system capable of executing a selected set of trained prediction models 4010. For example, the input data may be in the form of spectrogram data obtained from the skin of an individual. The technique further includes operating a selected set of prediction models for prediction based on the input data 4020. The set of prediction models is generally pre-stored in a memory unit being local or remote to the computer system. The set of prediction models may include a plurality of two or more, or three or more, prediction models, having two or more different topologies. Generally, the set of prediction models may be trained in accordance with the above-described technique, and utilizes evolutionary processing through two or more generations to further enhance exploration of the solutions space. The processing may be done in parallel processing, or in series. Each of the set of prediction models is used to process the input data to determine output data 4030. For example, the prediction model may be trained for prediction of a selected group of blood biomarkers, grouped in accordance with biological correlations between them, or in accordance with concentration levels. Thus, each of the prediction models may generate output data in the form of a list of numbers, each indicating concentration of one blood biomarker from the group of biomarkers. At this stage, the present technique utilizes the selected number of output data pieces for further estimating prediction accuracy. The technique generally operates one or more processors for determining statistical behavior of the different prediction outputs 4040. The statistical behavior can be determined based on average and variation measure of predictions distribution, e.g., using average and standard deviation. In some other embodiments the statistical data may be average, and percentage variation is defined by DIF %(i)(k)=abs(b(k)i−b(k))/b(k) where i runs over the number of prediction models, k indicates each piece of the output data (e.g., each biomarker in the group), b(k) is the average output, and b(k)i is the output of each prediction model i.

The variation between prediction outputs is compared to a selected first threshold 4050. For example, for some operations, variation is desired to be below 10%. If the variation is within the required threshold (YES) the average data is used to determine the output data 4060; the output data may also indicate that it is an average of a number # of predictions and within variation thresholds. If the variation exceeds the desired first threshold (NO), the variation may be compared to a selected second threshold 4070, e.g., 25% variation. In this case, if the variation exceeds the second threshold, the technique may generate an indication that no meaningful output data could be determined 4090. If the variation is between the desired thresholds, the output data may be provided as a set of predictions as obtained by the number of prediction models 4080.

This technique provides reliable output data, as well as providing an indication on the reliability of the output data, thus allowing prediction of medical and biomedical parameters with sufficient assurance and indication on whether the output data is insufficient.

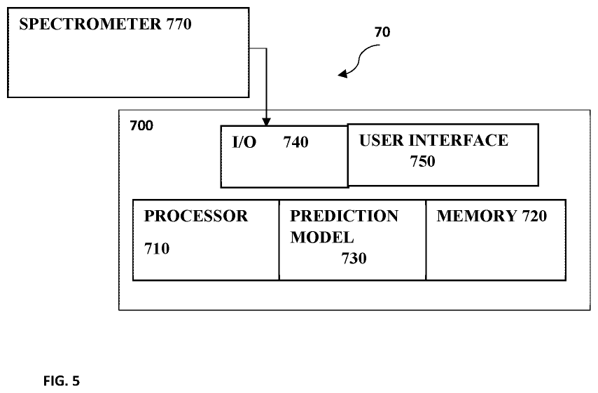

In this connection FIG. 5 illustrates a system 70 for non-invasive determination of one or more biomarkers of a patient (e.g., blood biomarkers). The system 70 generally includes a computer-based system 700 including at least one processor 710 and memory 720, typically defined as processor and memory circuitry (PMC). The system 70 may include, or be associated with, a spectrometer 770 configured to measure absorption levels in a selected spectral range, e.g., generally including 600-2700 nm from a user's tissue such as skin, as described above. The computer-based system 700 also includes suitable input and output communication module 740 for receiving input spectrogram data from the spectrometer when used, and may include user interface 750, e.g., including display, keyboard etc. The PMC is pre-stored with computer readable data indicative of a plurality of prediction models 730 trained for prediction of selected biomarkers based on spectrometric data. The plurality of prediction models includes a set of three or more prediction models trained for prediction of a common set of biomarkers and utilizing certain variations in model topology. Additionally, the system may include operational instructions for implementing the prediction models 730 and for processing of output prediction data as exemplified in FIG. 4 above. In particular, the processor can execute several computer-readable instructions implemented on a computer-readable memory stored or comprised in the PMC, wherein execution of the computer-readable instructions enables data processing of input data in the form of spectrogram data for determining one or more, or a group of biomarkers, based on the input data. In some additional embodiments the PMC may implement computer readable instructions for processing input data indicative of a spectrogram for operating one or more prediction models, and generate output data indicative of predicted biomarker concentration in a respective individual's blood.

Generally, it should be noted that the system 70 is illustrated herein in combination with a spectrometer 770 for clarity. Generally, the system 70 may be operable as a computer-based system and obtain patient spectrogram data via a communication link from a selected storage unit for non-invasively determining data on blood biomarkers at a remote location.

As indicated above, the processor 710 may operate to receive input data in the form of one or more spectrograms from the spectrometer 770 and operate the plurality of prediction models 730 in series or in parallel for predicting a group of biomarkers based on the input spectrogram data. The processor may further obtain output prediction data including quantifying prediction of biomarkers from a number of three or more (e.g., 3, 5, 8, 13, 17, 25 or 30) prediction outputs. The processing may operate to process the output prediction data and determine statistical parameters relating at least to variation of the different prediction outputs. The processor further determines if the variation measure of the prediction outputs is within a first threshold limits, exceeding first threshold limits and within second threshold limits, or exceeds the second threshold limits, and determines output data accordingly.

Generally, if the statistical variation of prediction outputs is within first threshold limits (e.g., 8% variation, or 10% variation, or 15% variation), the prediction is considered relatively accurate, and the processor 710 may generate output data indicating quantity of the selected one or more biomarkers to be the average of the prediction outputs.

In cases where the statistical variation of prediction outputs exceeds the first threshold, but is within the second threshold limits (e.g., 20% variation, or 25% variation or 30% variation), the prediction is considered to be of lower reliability. The processor 710 thus generates corresponding output data, e.g., provides average prediction and a set of the different prediction outputs, or average prediction marked as being of lower reliability.

In cases where the statistical variation exceeds the second threshold, the prediction output is of low reliability and the processor 710 operates to generate output indication of low-quality prediction. The output indication may indicate that biomarker prediction is undetermined, input data error, or other suitable messages, and may request for improved quality spectrometric data.

Generally, the selected set of prediction models may utilize various machine learning or Artificial Intelligence techniques, including, for example: Principal Component Analysis, Principal Component Regression, Partial Least Squares, Parallel Factor Analysis, N-way Partial Least Squares, Multiple Linear Regression, Hierarchical Cluster Analysis, K-nearest Neighbors, Support Vector Machines, Naïve Bayes, Linear or Normal Discriminant Analysis, Soft Independent Modeling of Class Analogy, Feedforward Neural Network, Recurrent Neural Network, Bayesian Regularization, Convolutional Neural Network, Generative Adversarial Network, or any other suitable prediction model configuration. Further, the prediction model may utilize a parallel or sequential chain of Artificial Intelligence techniques, chemometric techniques, and/or statistical modeling. The selected set of prediction models may utilize prediction models of different topologies. For example, the prediction models may differ in the number of nodes in each layer, number of processing layers, initial parameters, or other characteristics thereof.

Accordingly, the present disclosure further provides a method and system for use in data prediction using a set of three or more prediction models trained on prediction of selected data pieces in response to common input data. The method comprises providing input data, processing the input data by a set of three or more prediction models, e.g., prediction models trained as described herein, and obtaining three or more output data pieces. It further includes processing the output data pieces and determining statistical parameters of the output data pieces, and determining in accordance with statistical parameters between one or more output data. According to the present technique, if statistical variation of the output data pieces is within a first selected limit, the output data is determined by average of the output data pieces; if statistical variation is within a second selected limit, the output data is determined by providing the complete set of output data pieces and an indication of statistical variation; if statistical variation is outside of the selected limits, output data is generated, indicating that prediction could not be made.

The above-described method may be implemented by one or more processor and memory circuitries (PMCs), e.g., as exemplified in FIG. 5 above, where the PMC includes pre-stored data on a set of prediction models pre-trained for prediction of output data in response to common input data, as described herein.

In some configurations, the set of prediction models may be trained for prediction of a selected set of blood biomarkers in response to input data in the form of one or more spectrogram data obtained in a non-invasive manner from living tissue of an individual. The selected set of biomarkers may be a group of biomarkers groups together in accordance with one or more parameters, such as biological correlation, concentration levels, etc.

Thus, the present technique, utilizing improved training, and possibly also utilizing improved data output reliability, may be used for precision and quantification of blood biomarkers. The present disclosure provides non-invasive and simple prediction of blood biomarkers, and eliminates, or at least significantly reduces, the need to draw blood from a patient.

In this connection, it should be clear to a person skilled in the art that the present disclosure may utilize various types of input data, in accordance with objectives of the technique, training, and functionality requirements. As indicated herein, in some embodiments, the present disclosure may utilize spectrogram data for prediction of blood biomarkers. Such spectrogram data may be within any selected spectral range, including, but not limited to, infrared, near-Infrared, mid-Infrared, far-Infrared, visible light, UVA, UVB, UVC, microwave, Raman, RF frequencies, etc.

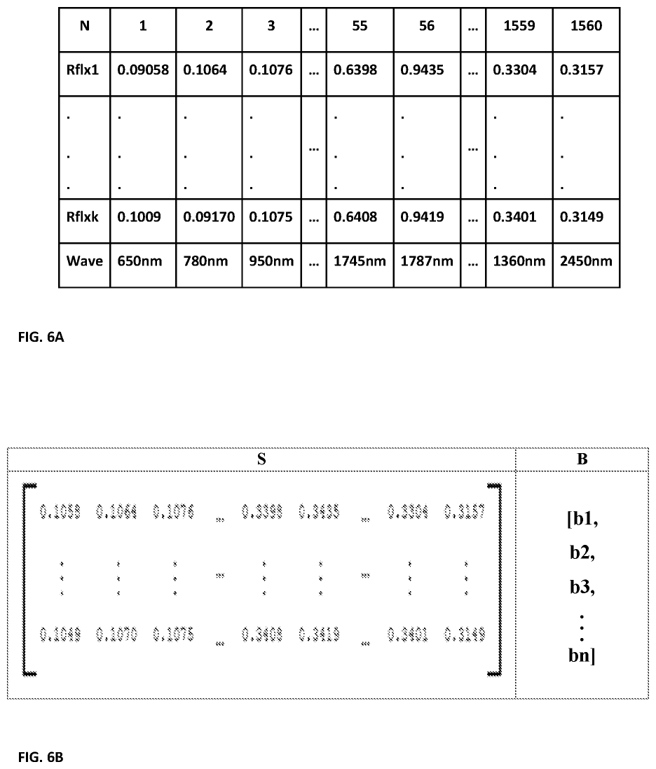

In this connection, reference is made to FIGS. 6A and 6B exemplifying spectrogram data and a spectrogram-blood biomarkers pair respectively. Spectrogram data is exemplified in FIG. 6A showing absorption levels for different wavelengths collected in a selected number of sampling instances. Data pieces, including spectrogram and respective biomarkers' data, are illustrated in FIG. 6B where the biomarkers' data is presented in a list of biomarkers (bₙ) obtained by analysis of blood samples. Generally, each spectrogram data piece may be collected from an individual, using reflection-, transmission- and/or absorbance-based spectrometric detection, and may be collected from the individual's skin, e.g., on the wrist, or other places. Such spectrometric data may be collected by non-invasive means that do not cause pain or discomfort to the patient, other than the need to be relatively stationary for a period, for spectrometric data collection. Generally, a complete near infrared (NIR) spectrogram may require about 1 second acquisition time. However, to provide reliable output data, the present technique may utilize collection of a selected number of spectrogram scans, collected within a period of between 10 seconds and 2 minutes. This acquisition time is directed at blood circulation time through the patient's blood system. To provide labeling data, each individual also provides a blood sample that is taken to a laboratory to obtain blood analysis indicating desired blood biomarkers. Blood biomarker results (B) are collected and used to label the spectrogram data, providing a plurality of data pieces indicative of spectrogram data and respective blood biomarkers' data obtained from a plurality of individuals.

Generally, in some embodiments, the input spectrogram data may be pre-treated. The pre-treatment may include selected operations on the collected spectrogram such as, but not exclusively, baseline normalization, spectrum truncation, signal-to-noise ratio optimization, signal cleaning, spectrum derivation, band deletion, among others, as well as spectrum averaging. Pre-treatment can be carried out at the time of collection of the spectrogram, or directly on the input data.

As is known in the state of the art, spectrogram data may have noise, and an incorrect spectral acquisition will present more noise. If, for at least one channel of the spectrograms present measured values are outside of a predetermined range, e.g., outside of a standard deviation value, then the entire spectrogram is discarded. Otherwise, the spectrogram is kept, and quantification is performed using the set as input. In a preferred embodiment, the predetermined range is anywhere from 0.01 to 0.1.

To provide proper labeling of the input training data, the training data set may include data on the real concentration bₙ of n blood markers of a user. This data may be obtained by any known conventional means, such as by means of traditional blood tests for any commonly tested blood marker. This data is then used by the method of the present invention as a vector of values B, i.e., as a table with one column and n number of rows, each row comprising the real concentration bₙ of one blood marker. This vector B will be used as target data for the method of the present invention for purposes of calibration or building prediction models.

The datasets used for the method of the present disclosure may thus include a plurality of “S-B pairs”. The S-B pairs are added to a database, which can comprise any number i of S-B pairs, individually named Sᵢ-Bᵢ pairs. As seen in FIG. 6B, Sᵢ may refer to the matrix of spectra and Bᵢ to vector B—the input and the target, respectively. Each Sᵢ-Bᵢ pair comes from one user and is added to a database. The database is used by the method of the present invention for purposes of calibration, validation, and testing. As can be understood by a person skilled in the art, S-B pairs refer to all Sᵢ-Bᵢ pairs in the database, with S and B individually referring to all Sᵢ matrices and to all Bᵢ vectors, respectively.

The spectrogram data Sᵢ pieces may be pre-processed, or pre-treated, using one or more techniques such as baseline normalization, spectrum truncation, signal-to-noise ratio optimization, signal cleaning, spectrum derivation, band deletion, spectrum averaging, etc. Pre-processing of the spectrogram data pieces may be directed at reducing noise associated with measurement apparatus and movement, as well as defining spectral range between the entire data set. The pre-processing may be performed at the time of spectrogram collection and/or following collection of the entire data set. Further, the collected spectrograms may be assessed for noise levels and consistency. For example, spectrogram data pieces that are overly noisy, or are inconsistent (e.g., standard deviation above a selected threshold between instances of spectrograms collected from a single individual) may be disregarded and discarded, together with the respective blood biomarker data.

To improve prediction accuracy of the model, the present disclosure generally utilizes determining a selected number of groups of biomarkers. The list of biomarkers for which the prediction model is directed may be any list of materials that may exist in a person's blood and may be a target for analysis. Such biomarkers may include, for example: red blood cells count (RBC), hemoglobin, hematocrit, Mean Corpuscular Volume (MCV), Mean Corpuscular Hemoglobin (MCH), Mean Corpuscular Hemoglobin Concentration (MCHC), platelets, Mean Platelet Volume (MPV), Red blood cell distribution width (RDW), Absolute Neutrophils, Absolute Lymphocytes, Absolute Monocytes, Absolute Eosinophils, Absolute Basophils, Total Cholesterol, Triglycerides, Low Density Lipoprotein (LDL-C), High Density Lipoprotein (HDL-C), Glucose, Blood Urea Nitrogen, Creatinine, Sodium, Potassium, chloride, Carmon dioxide, Uric Acid, Albumin, Globulin, Calcium, Phosphorus, Alkaline Phosphatase, Alanine amino transferase (ALT or SGPT), Aspartate amino transferase (AST or SGOT), LDH, Total Bilirubin, GGT, Iron, TIBC, C-Reactive Protein, Cortisol, DHEA-Sulfate, Estimated Glomerular Filtration Rate (eGFR), Estradiol, Ferritin, Folate, Hemoglobin A1c, Homocysteine, Progesterone, Prostate Specific Ag (PSA), Testosterone, Thyroid-Stimulating Hormone, Vitamin D, or any other biomarkers that may be a target for biomedical analysis.

From this list, the biomarkers may be separated into groups of two or more biomarkers selected in accordance with one or more parameters such as typical concentration levels, and/or level of effect of the biomarker on spectrogram data. Each biomarker may be characterized by typical amount present in a selected blood volume, and this amount may be weighted to indicate spectral absorbance effect of the biomarker. The biomarkers may be arranged in groups including two or more biomarkers characterized by a high amount (concentration) and one or more biomarkers characterized by a low amount (concentration). The various biomarkers are arranged in a selected number of groups, such that each group includes two or more (preferably three or more) biomarkers. Generally, some or all of the biomarkers included in the model are placed in two or more groups each. In some embodiments, the various biomarkers may be arranged in a selected number of groups, such that each group includes two or more (preferably three or more) biomarkers. Generally, some or all of the biomarkers included in the model are placed in two or more groups each.

These groups of biomarkers may be established based on biochemical correlations known in physiology and medicine, concentration levels, or other selected characteristics. As a way of example, it is known in the area of physiology that metabolic changes in the kidneys can influence changes in the concentration of several blood markers such as uric acid, sodium, and hemoglobin, among others, which are directly affected by the physiology of the kidney. All blood markers that have these sorts of metabolic relationships are considered to be “biochemically correlated” and are grouped accordingly. Grouping the blood markers referred to in this example may include a group consisting of uric acid, sodium, and hemoglobin. The groups may be established so that the same blood marker is present in at least one different group, preferentially in at least two different groups, each group preferentially including at least two blood markers, and may include between 2 and 20 blood biomarkers. In a preferred embodiment, each group optimizes one blood marker, however more blood markers can also be optimized from one group.

Considering that the concentration of dozens of blood markers can be calculated by the present technique, many different groups can exist. The present technique thus provides a prediction route, including a selected number of prediction models, typically trained as indicated above for prediction of parameters of each group. Generating prediction output may utilize statistical data as exemplified in FIGS. 4 and 5 above to provide output prediction data on a group of biomarkers with data on accuracy of prediction. Thus, each group of biomarkers may be predicted by a selected set of prediction models including, e.g., 2-35 prediction models varying between them by some prediction parameter, topology etc.

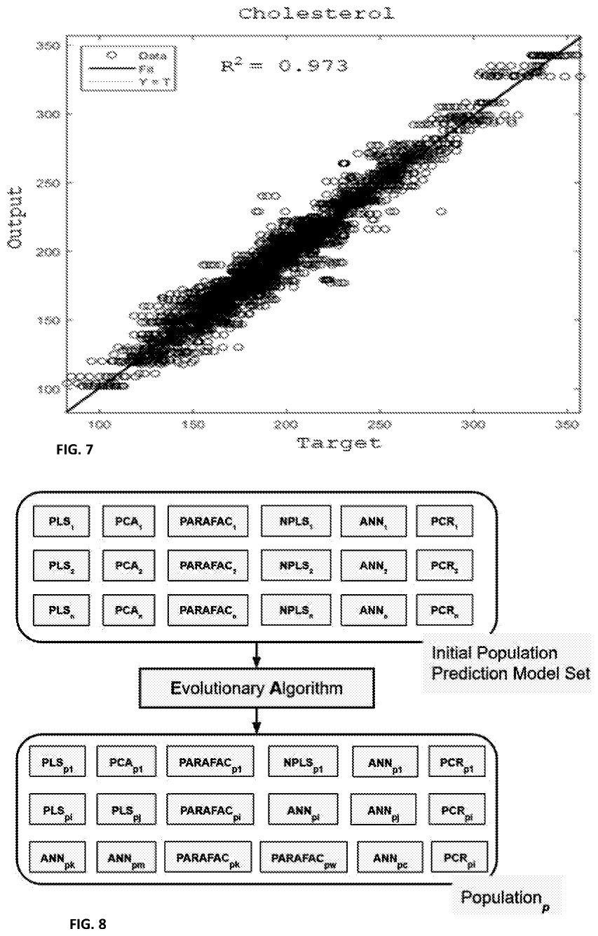

Generally, in some embodiments, an accuracy measure may be associated with a correlation value for each specific biomarker. In some embodiments, the correlation values may be the statistical coefficient of determination, also known as R². In this connection, reference is made to FIG. 7 exemplifying correlation factor R² for cholesterol determined based on an input data set. Generally, to provide an accurate prediction, the accuracy measure is preferred to be sufficiently high, i.e., closer to one. However, as the prediction model of the present disclosure is generally directed at predicting a plurality of biomarkers that are generally not directly correlated, the accuracy measure R² is preferred to be lower than one, to allow a certain flexibility due to variations between individuals, and specifically to avoid overfitting to the training data set. Accordingly, in some embodiments, sufficient accuracy at the validation stage may be determined within the range of R² between 0.70 and 0.99. Further, at the testing stage, sufficient accuracy may be determined based on R² in the range between 0.65 and 0.99. Typically, the selected ranges may vary in accordance with size of the data set and clinical relevance of the blood biomarkers. As indicated above, if the correlation value for at least one biomarker within a group is outside the desired range, the respective prediction route may be retrained by repeating calibration and validation stages following a shuffled data set.

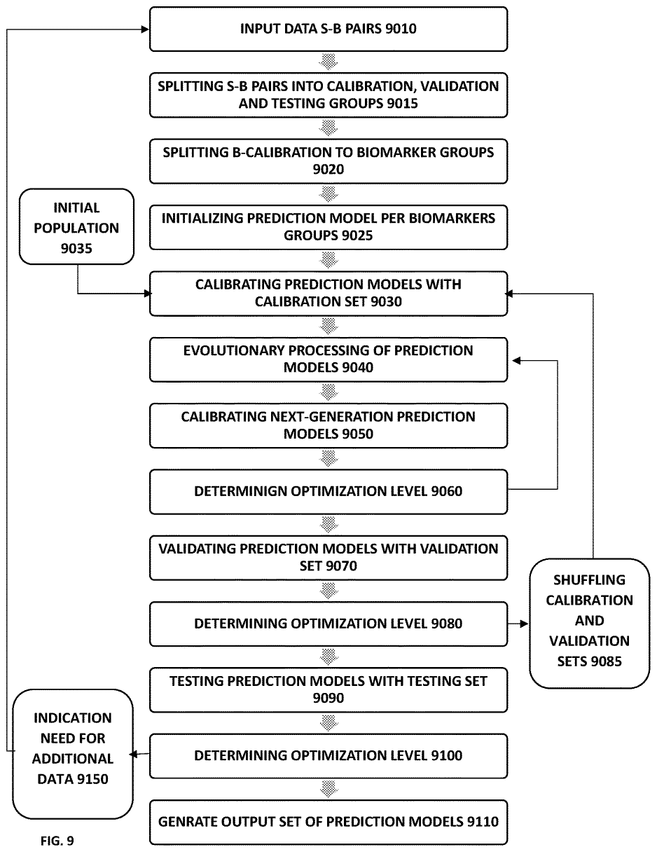

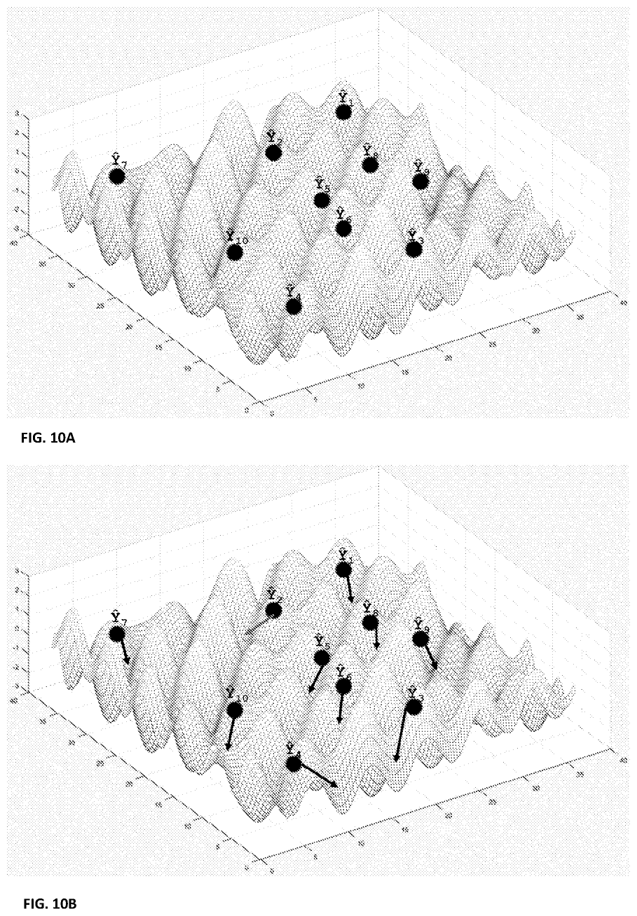

FIGS. 8 and 9 exemplify a specific processing of the technique according to some embodiments of the present disclosure. FIG. 8 exemplifies operation of evolutionary processing on a set of current generation prediction models, generating a set of next-generation prediction models. FIG. 8 is a flow diagram that illustrates the application of evolutionary processing in a specific and non-limiting example of the present technique. During the first instance of the calibration phase, the chemometric algorithms are optimized starting from randomly selected parameters. These parameters are then adjusted for all algorithms in order to reach the best Ŷ_{Gi} predictions for all algorithms through the use of S-B pairs. These algorithms make up an initial population that will be submitted to an EA (Evolutionary Algorithm processing technique/module). After the result of the mixing and/or interference processes are performed by the EA, new algorithms are obtained which present initial parameters derived from the parameters of the selected algorithms, as opposed to the random parameters with which the first chemometric algorithms began. For this reason, new algorithms are considered a new generation, termed, as shown in FIG. 8, as Population P. New generations are calibrated anew, but use mixed sets of parameters from the previous population as a starting point. Since this process is repeated indefinitely, new Populations Pᵢ are always obtained from the previous generation of algorithms. In this optimization process with EA, as shown in FIG. 8, some chemometric algorithms may no longer be selected and not even participate in future populations, i.e., an EA additionally filters the types of chemometric algorithms that obtain the most consistent results from those with inferior results. This filtering occurs per group G of biochemically correlated blood markers, obtaining the best method for each group, or even the methods that provide the global optimum solution for each group. EA optimization additionally mitigates overfitting of Ŷ_{Gi} predictions, by not excessively optimizing in one local optima.

In this connection, FIG. 9 illustrates a specific and non-limiting example of training a set of prediction models according to some embodiments of the present disclosure. As shown, the technique includes obtaining/providing input training data 9010. The training data may generally include a plurality of pairs of spectrogram data S and blood biomarker data B, forming S-B pairs. The input data set is split into three portions 9015, including calibration set, validation set, and testing set. In some cases, the calibration set may include 40%-60% of the data, the validation set may include 30%-50% of the data, and the testing set may include 10%-30% of the data. Generally, data pieces may not overlap between the sets. The biomarker data B may be split into groups of biomarkers in accordance with biological correlations, concentration levels, or others 9020, and the prediction is performed for each group of biomarkers independently. Thus, the technique includes initializing prediction models per biomarkers' groups 9025.

For a selected group of biomarkers, the prediction models, including a set of different prediction topologies and algorithms, are calibrated 9030, using random initial populations 9035. Following calibration of first-generation prediction models, the technique utilizes one or more evolutionary processing techniques (evolutionary algorithms) to determine next-generation prediction models 9040, and calibrates the next-generation prediction models 9050 providing current-generation prediction models. This process may be performed a selected number of generations, or utilize determining optimization level of the current-generation prediction models 9060. If the optimization level is insufficient, the technique repeats evolutionary processing 9040 and calibrating 9050, until the optimization level is sufficient.

Following sufficient optimization in calibration, the technique further operates to validate the prediction using the validation set of the input data 9070. Validation may generally also include optimization of prediction operations, as in training. The optimization level after validation is determined 9080, and, if insufficient, the method may operate for reshuffling of the calibration and validation data sets, and repeat calibration 9030. If validation optimization level is sufficient, the prediction models may be further tested using the testing data set 9090. Testing of the prediction models may generally not include any optimization adjustments, and may only verify accuracy of the prediction for the new data set. Determining the optimization level after testing 9100 may lead to generating an output set of the prediction models 9110 if the optimization level is sufficient. If the optimization level is insufficient, it may be associated with insufficient training data, and the method may generate a request for additional training data 9150.

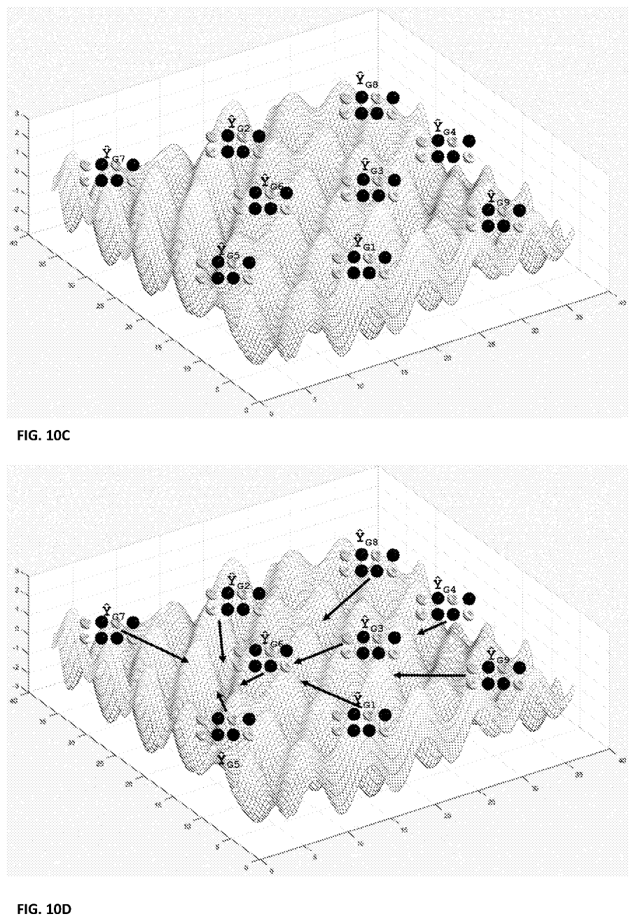

Generally, as indicated above, the present disclosure utilizes evolutionary processing to better explore solution space. Additionally, the present disclosure may also utilize grouping of target biomarkers in accordance with preselected characteristics. This enables the present technique to provide improved prediction accuracy. Reference is made to FIGS. 10A to 10D illustrating an optimization process for a prediction model and exemplifying the advantage of the present technique. FIGS. 10A and 10B illustrate, respectively, certain prediction solutions utilizing a plurality of prediction solutions Ŷ₁ to Ŷ₁₀, each associated with a single biomarker, and expected convergence following further optimization steps. FIGS. 10C and 10D illustrate, respectively, prediction solutions Ŷ_{G1} to Ŷ_{G9} for a number of groups of biomarkers and expected convergence following optimization steps.

Generally, the dispersion of prediction solutions illustrated in FIG. 10A for prediction of biomarkers one-by-one has similar characteristics to the solution dispersion associated with prediction of the entire set of biomarkers together. In both cases, the level of data variability is sufficiently high, resulting in over-fitting of the prediction to the data provided for training, such that the final solution does not converge with new input.

Alternatively, the present technique utilizes optimization of selected sets of groups of biomarkers. This technique maintains a small number of local optima, and similarity in characteristics of the different biomarker results in several groups converging together.

The technique of the present disclosure was tested against methods commonly used in the state of the art. Concentrations of blood markers were predicted from S-B pairs one at a time (Ŷᵢ), all at the same time (Ŷ), or by splitting B into different B_{G} groups (Ŷ_{Gi}). The calibration phase used a calibration set with 60% of the total number of S-B pairs present in the database. The validation and testing phases used a validation set and a testing set, respectively, with 20% of all S-B pairs in the database.

The results obtained are summarized in the table below. The correlation values (R²) presented for each method are the average of all R² values for all selected Ŷ, Ŷᵢ, or Ŷ_{Gi} predictions for every blood marker. As observed, algorithm optimization was initially more efficient for the method of quantifying one blood marker at a time. However, the final results were consistently better for the method with grouping, i.e., the method of the present invention.

TABLE 1

| | Calibration phase | Validation phase | Testing phase |
|---|---|---|---|
| Method | (R²) - S_{C}-B_{C} | (R²) - S_{V}-B_{V} | (R²) S_{T}-B_{T} |
| One-by-one | 0.965 | 0.932 | 0.613 ± 0.227 |
| All together | 0.867 | 0.860 | 0.400 ± 0.196 |
| With grouping | 0.942 | 0.914 | 0.861 ± 0.181 |
| With grouping + | 0.970 | 0.941 | 0.891 ± 0.176 |
| EA optimization | | | |

Even though the result for the method of quantifying one blood marker at a time was better in the calibration and validation phases, the results from this algorithm are not necessarily clinically relevant. Since no grouping is present, the algorithm will not observe relationships between the concentrations of blood markers. Therefore, the result obtained will be any optimum that is obtained by optimization of the loss function, even if one or more concentration values are physiological impossibilities. With the concentrations of all blood markers being calculated at the same time, a global optimum is extremely hard to obtain, and relations between blood markers are uncertain. Therefore, the result is not only poor, but is most likely not clinically relevant, which can be observed in the results for the testing phase. With the grouping of blood markers based on biochemical correlations, the algorithm will observe relationships between concentration values, which assists in obtaining a global optimum, and also with obtaining coherent concentration values. The application of the EA optimization step is shown to further improve the results obtained, being therefore a good optimization step for the method of the present disclosure.

As indicated above, the present technique may be implemented by one or more computer systems using the respective one or more processors and memory circuitries. The system may be directly connected to a spectrometer for providing on-the-spot blood biomarkers data, or positioned in a selected location to provide network processing and/or offline biomarker prediction processing.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1.-37. (canceled)

38. A method implemented by a processor and memory circuitry (PMC), the method comprising:
(a) providing a training data set;
(b) training a selected number of prediction models using at least a first portion of said training data set to provide a selected number of first-generation prediction models;
(c) processing said selected number of first-generation prediction models using one or more evolutionary algorithm processing techniques, and generating a selected number of next-generation prediction models;
(d) training said selected number of next-generation prediction models using said first portion of said training data, generating a number of current-generation prediction models;
(e) processing said selected number of current-generation prediction models using one or more evolutionary algorithm processing techniques, and generating a selected number of next-generation prediction models;
(f) repeating actions (d) and (e) for a selected number of generations until an accuracy measure of current-generation prediction models reaches a preselected training accuracy threshold; and
(g) providing output data comprising a selected number of current-generation prediction models.

39. The method of claim 38, wherein said training a selected number of prediction models (b) comprises determining random initial parameters for each prediction model and training said prediction models starting from said random initial parameters.

40. The method of claim 38, wherein said training said selected number of next-generation prediction models (d) comprises using parameters of said next-generation prediction models as initial parameters for training.

41. The method of claim 38, wherein said processing said selected number of current-generation prediction models using one or more evolutionary algorithm processing techniques comprises introducing a selected ratio of mutations in said evolutionary algorithm processing.

42. The method of claim 38, further comprising validating a training status of said selected current-generation prediction models using at least a second portion of said training data set.

43. The method of claim 42, further comprising determining an accuracy measure for validation training of said selected current-generation prediction models, and repeating training (d) if accuracy measure is below a selected threshold.

44. The method of claim 43, further comprising mixing said first and second portions of the training data set for repeating training.

45. The method of claim 38, further comprising testing said selected number of current-generation prediction models using at least a third portion of the training data set and determining testing accuracy measure for said selected number of current-generation prediction models.

46. The method of claim 45, wherein if said testing accuracy measure is below a preselected threshold, generating a request for additional training data.

47. The method of claim 38, wherein said training data set comprises spectrogram data pieces obtained from a plurality of individuals and respective data on a selected set of blood biomarkers of said individuals, said training said prediction model being directed at prediction of a selected group of biomarkers based on input spectrogram data of an individual.

48. The method of claim 47, wherein said selected group of biomarkers comprises at least one of:
biomarkers selected in accordance with biological correlation between them; or
two or more biomarkers characterized by typical spectral effect above a first threshold, and one or more biomarkers characterized by typical spectral effect below a second threshold.

49. The method of claim 47, wherein said selecting one or more groups of biomarkers comprises pairing two or more biomarkers characterized by typical spectral effect above a first threshold, and one or more biomarkers characterized by typical spectral effect below a second threshold.

50. The method of claim 47, wherein said spectrogram data obtained from a plurality of individuals comprises a plurality of spectrogram readings collected within a selected timeframe associated with blood circulation of a selected portion of an individual's blood volume.

51. The method of claim 47, wherein said spectrogram data is indicative of spectral absorption within a range between 600-2700 nm.

52. The method of claim 38, wherein said selected number of prediction models comprises prediction models selected from a group comprising: Principal Component Analysis, Principal Component Regression, Partial Least Squares, Parallel Factor Analysis, N-way Partial Least Squares, Multiple Linear Regression, Spectral Match Value, Moving Block, Hierarchical Cluster Analysis, K-nearest Neighbors, Support Vec Machines, Naïve Bayes, Linear or Normal Discriminant Analysis, Soft Independent Modeling of Class Analogy, Feedforward Neural Network, Recurrent Neural Network, Bayesian Regularization, Convolutional Neural Network, and Generative Adversarial Network.

53. The method of claim 38, further comprising storing said output data comprising a selected number of current-generation prediction models in a computer readable medium in the form of a set of pre-trained prediction models for use in prediction of blood biomarkers based on input data comprising spectrometric data obtained by non-invasive spectrometric reading of an individual's living tissue.

54. The method of claim 53, wherein said use in prediction of blood biomarkers comprises:
(h) obtaining, using a spectrometer, one or more spectrograms from an individual's living tissue;
(i) processing said one or more spectrograms using said set of pre-trained prediction models to obtain a set of predictions for one or more biomarkers;
(j) processing said set of predictions for said one or more biomarkers and determining at least statistical variation between predictions of said set of pre-trained prediction models;
(k) processing said statistical variation and determining relation of said statistical variation to at least first and second variation limits such that:
i) if statistical variation is within the first variation limit, determining output data comprising an average of said output prediction data pieces;
ii) if statistical variation is within the second variation limit, determining output data comprising said output prediction data pieces and said statistical variation; and
iii) if statistical variation data is outside said second variation limit, determining output data as being undetermined;
(l) generating an output signal comprising said output data indicating one or more biomarkers of said individual.

55. The method of claim 54, wherein said set of pre-trained prediction models is configured to predict a common set of biomarkers.

56. A program storage device readable by machine, tangibly embodying a program of instructions executable by the machine to perform a method comprising:
(m) providing a training data set;
(n) training a selected number of prediction models using at least a first portion of said training data set to provide a selected number of first-generation prediction models;
(o) processing said selected number of first-generation prediction models using one or more evolutionary algorithm processing techniques, and generating a selected number of next-generation prediction models;
(p) training said selected number of next-generation prediction models using said first portion of said training data, generating a number of current-generation prediction models;
(q) processing said selected number of current-generation prediction models using one or more evolutionary algorithm processing techniques, and generating a selected number of next-generation prediction models;
(r) repeating actions (d) and (e) for a selected number of generations until an accuracy measure of current-generation prediction models reaches a preselected training accuracy threshold;
(s) providing output data comprising a selected number of current-generation prediction models.

57. A system comprising a processor and memory circuitry (PMC), wherein the PMC is configured to:
(t) obtain a training data set;
(u) utilize at least a first portion of said training data set to train a selected number of prediction models and provide a selected number of first-generation prediction models;
(v) process said selected number of first-generation prediction models by one or more evolutionary algorithm processing techniques, and generating a selected number of next-generation prediction models;
(w) train said selected number of next-generation prediction models using said first portion of said training data, generating a number of current-generation prediction models;
(x) process said selected number of current-generation prediction models using one or more evolutionary algorithm processing techniques, and generating a selected number of next-generation prediction models;
(y) repeat actions (d) and (e) for a selected number of generations until an accuracy measure of current-generation prediction models reaches a preselected training accuracy threshold;
(z) provide output data comprising a selected number of current-generation prediction models.
